(19) United States
(12) Patent Application Publication
(10) Pub. No.: US 2012/0280963 A1
(43) Pub. Date: Nov. 8, 2012

(54) PLASMA DISPLAY PANEL DRIVING METHOD AND PLASMA DISPLAY DEVICE

(76) Inventors: Keiji Akamatsu, Hyogo (JP); Yuichi Sakai, Osaka (JP); Minoru Takeda, Osaka (JP); Hidehiko Shoji, Osaka (JP); Naoyuki Tomioka, Osaka (JP)

(21) Appl. No.: 13/522,260

(22) PCT Filed: Jan. 19, 2011
(86) PCT No.: PCT/JP2011/000240

§ 371 Date: Jul. 13, 2012

(30) Foreign Application Priority Data
Jan. 19, 2010 (JP) 2010-008773

(51) Int. Cl. G09G 5/00; G09G 3/28

(52) U.S. Cl. 345/211; 345/60

(57) ABSTRACT

The present invention allows a plasma display apparatus having a high-luminance panel to decrease initializing bright points that easily occur just after power-on of the apparatus, enhancing the quality of display image. The panel has discharge cells, each of which including a data electrode, and a display electrode pair formed of a scan electrode and a sustain electrode. In the driving method of the panel, one field period is formed of subfields, each of which including an initializing period for generating initializing discharge in the discharge cells, an address period for applying scan pulses to the scan electrodes and applying address pulses to the data electrodes, and a sustain period for applying sustain pulses to the data electrode pairs. In the structure above, a predetermined period after power-off of the apparatus has no generation of the address pulses, the scan pulses, and the sustain pulses.

### TECHNICAL FIELD

The present invention relates to a method of driving a plasma display panel used for wall-hanging TVs or large monitors and also relates to a plasma display apparatus driven by the method.

### BACKGROUND ART

An AC surface discharge panel, i.e. a typical plasma display panel (hereinafter, simply referred to as a “panel”), has a plurality of discharge cells between a front substrate and a rear substrate oppositely disposed to each other. On a glass substrate of the front substrate, a plurality of display electrode pairs, each including a scan electrode and a sustain electrode, is arranged in parallel with each other. A dielectric layer and a protective layer are formed over the display electrode pairs.

On a glass substrate of the rear substrate, a plurality of data electrodes is arranged in parallel with each other, and over which, a dielectric layer is formed so as to cover them. On the dielectric layer, a plurality of barrier ribs is formed so as to be parallel with the data electrodes. A phosphor layer is formed on the surface of the dielectric layer and on the side surface of the barrier ribs.

The front substrate and the rear substrate are oppositely located in a manner that the display electrode pairs are positioned orthogonal to the data electrodes, and the two substrates are sealed with each other via discharge space therebetween. The discharge space is filled with a discharge gas, for example, containing xenon at a partial pressure of 5%. Discharge cells are formed at intersections of the display electrode pairs and the data electrodes. In the panel with the structure above, ultraviolet rays are generated by gas discharge in each discharge cell. The ultraviolet rays excite phosphors of the red (R) color, green (G) color, and blue (B) color so that light is emitted for the display of a color image.

A typically used driving method of the panel is a subfield method. In the subfield method, gradations are displayed by dividing one field period into a plurality of subfields and causing light emission or no light emission in each discharge cell in each subfield. Each of the subfields has an initializing period, an address period, and a sustain period.

In the initializing period, a voltage with an initializing waveform is applied to each scan electrode to generate an initializing discharge in each discharge cell. The initializing discharge forms wall charge necessary for the subsequent address operation, and generates priming particles (i.e., excited particles for generating a discharge) for providing an address discharge with stability.

In the address period, scan pulses are sequentially applied to the scan electrodes, at the same time, address pulses are selectively applied to the data electrodes according to an image signal to be displayed. The application of voltage generates an address discharge between a scan electrode and a data electrode at a discharge cell to have light emission, and forms wall charge in the discharge cell (hereinafter, the address operation is also referred collectively as “addressing”).

In the sustain period, sustain pulses in number predetermined for each subfield are applied alternately to the scan electrodes and the sustain electrodes of the display electrode pairs. The application of the pulses generates a sustain discharge in the discharge cells having undergone the address discharge and causes the phosphor layers to emit light in the discharge cells, by which each discharge cell emits light at a luminance corresponding to a luminance weight determined for each subfield. (Hereinafter, light emission of a discharge cell caused by a sustain discharge may be represented by “light-on” and no light emission of a discharge cell may be represented by “light-off”). Thus, each discharge cell of the panel emits light at a luminance corresponding to the gradation values of image signals, displaying an image in the image display area of the panel.

To drive the panel, the plasma display apparatus has a scan electrode driver circuit, a sustain electrode driver circuit, and a data electrode driver circuit. Each of the driver circuit applies a driving voltage waveform to each electrode to display an image on the panel.

As an attempt of the subfield method, a driving method having an improvement in contrast ratio has been disclosed. In the method, an initializing discharge is generated by a voltage waveform with a moderate change, and further, an initializing discharge is generated selectively in the discharge cells having undergone a sustain discharge. As a result, the light emission unrelated to gradation display is minimized, which contributes to enhanced contrast ratio.

Specifically, out of a plurality of subfields, one subfield has an all-cell initializing operation in the initializing period, and other subfields have a selective initializing operation in each initializing period. In the all-cell initializing operation, an initializing discharge is generated in all the discharge cells. In the selective initializing operation, an initializing discharge is generated only in the discharge cells having undergone a sustain discharge in the sustain period of the immediately preceding subfield (for example, see patent literature 1).

That is, the area that displays luminance of black (hereinafter, black luminance) due to no sustain discharge has only weak light emission caused by the all-cell initializing operation. As a result, the light emission unrelated to gradation display can be decreased, which enhances the contrast ratio of display image.

Recently, with the trend moving toward increasingly greater size and definition of the panel of a plasma display apparatus, manufacturers are seeking further improvements in quality of image display. Enhancing luminance of a panel is an effective method for improvements in quality of image display. Besides, increase in luminance of a panel contributes to decrease in power consumption. From the reasons above, suggestions have been made for achieving high luminance of a panel.

To obtain high luminance, increasing the ratio of xenon partial pressure is known as an effective way. Increase in the partial pressure ratio of xenon, however, also increases time lag between actual generation of discharge and application of voltage exceeding a discharge start voltage (hereinafter referred to discharge delay).

The discharge delay can cause a strong discharge in an all-cell initializing operation. The strong discharge further induces a false discharge, allowing a discharge cell to have a sustain discharge in spite of no addressing. As a result, the discharge cell has unintended light emission (hereinafter referred to initialization bright points).

As described above, enhancing luminance efficiency by increase in partial pressure ratio of xenon can cause initialization bright points due to discharge delay.

The aforementioned strong discharge can occur in the panel at a start of driving. In a panel just after power-on of the plasma display apparatus, discharge cells have not enough priming particles, at the same time, abnormal wall charge is often remained in the discharge cells. In an all-cell initializing operation performed just after the start of driving, a strong discharge can be induced.

In the plasma display apparatus having a panel with enhanced luminance efficiency by increase in xenon partial pressure, the initialization bright points easily occur on the panel just after power-on of the apparatus, by which display image at a start of driving seems to have poor quality.

### CITATION LIST

### Patent Literature

### PTL1

Japanese Patent Unexamined Publication No. 2000-242224

### SUMMARY OF THE INVENTION

The present invention provides a method of driving a panel with a plurality of discharge cells having data electrodes and display electrode pairs formed of scan electrodes and sustain electrodes, using a plurality of subfields that forms one field period. Each of the subfields has an initializing period where an initializing discharge is generated in the discharge cells, an address period where scan pulses are applied to the scan electrodes and address pulses are applied to the data electrodes, and a sustain period where sustain pulses are applied to the display electrode pairs. In addition, a predetermined period just after power-off of the plasma display apparatus has no generation of address pulses, scan pulses, and sustain pulses.

The structure above addresses the problem that the initialization bright points easily occur on the panel with enhanced luminance by increase in xenon partial pressure at a start of driving the plasma display apparatus. That is, the structure decreases the generation of the initialization bright points, enhancing quality of display image.

The plasma display apparatus of the present invention includes the following elements:
a panel having a plurality of discharge cells arranged therein, each of the discharge cells having a data electrode and a display electrode pair of a scan electrode and a sustain electrode;
a driver circuit for driving the panel; and
a main switch for turning on/off of a power supply that feeds power to the driving circuit.

The driver circuit drives the panel while one field period includes a plurality of subfields, each of the subfields has an initializing period where an initializing discharge is generated in the discharge cells, an address period where an address discharge is generated in the discharge cells, and a sustain period where a sustain discharge is generated in the discharge cells. The driver circuit generates a driving voltage waveform to be applied to the scan electrodes, the sustain electrodes, and the data electrodes. After a turn-off of the main switch, an all-cell initializing waveform for generating an initializing discharge in all the discharge cells is applied to the scan electrodes two or more times.

The structure above addresses the problem that the initialization bright points easily occur on the panel with enhanced luminance by increase in xenon partial pressure at a start of driving the plasma display apparatus. That is, the structure decreases the generation of the initialization bright points, enhancing quality of display image.

In the structure of the present invention, the driving circuit of the present invention may set the application cycle of the all-cell initializing waveform, to be applied to the scan electrodes after the turn-off of the main switch, so as to have a length smaller than that of one field period.

In the structure of the present invention, the driving circuit of the present invention may set an initializing voltage of the all-cell initializing waveform, to be applied to the scan electrodes after the turn-off of the main switch, higher than an initializing voltage of an all-cell initializing waveform to be applied in normal operation state.

### BRIEF DESCRIPTION OF THE DRAWINGS

FIG. 1 is an exploded perspective view showing the structure of a panel for use in a plasma display apparatus in accordance with a first exemplary embodiment of the present invention.

FIG. 2 is an electrode array diagram of the panel for use in the plasma display apparatus in accordance with the first exemplary embodiment.

FIG. 3 is a chart of driving voltage waveforms applied to respective electrodes of the panel used for the plasma display apparatus in accordance with the first exemplary embodiment.

FIG. 4 is a circuit block diagram of the plasma display apparatus in accordance with the first exemplary embodiment.

FIG. 5 is a graph showing the relation between a generation level of the initialization bright points just after power-on of the plasma display apparatus and the length of an off-preparation period in accordance with the first exemplary embodiment.

FIG. 6 is a circuit diagram showing the structure of the scan electrode driver circuit of the plasma display apparatus in accordance with the first exemplary embodiment.

FIG. 7 is a circuit diagram showing the structure of the data electrode driver circuit of the plasma display apparatus in accordance with the first exemplary embodiment.

FIG. 8 is a chart of driving voltage waveforms applied to respective electrodes in the off-preparation period in accordance with a second exemplary embodiment.

FIG. 9 is a graph showing the relation between a generation level of the initialization bright points just after power-on of the plasma display apparatus and the length of the off-preparation period in accordance with the second exemplary embodiment.

FIG. 10 partly shows the circuit diagram of the scan electrode driver circuit in accordance with a third exemplary embodiment.

FIG. 11 shows a waveform of voltage to be applied to the scan electrodes in the off-preparation period in an all-cell initializing operation in accordance with the third exemplary embodiment.

### DESCRIPTION OF EMBODIMENTS

Hereinafter, a plasma display apparatus in accordance with an exemplary embodiment of the present invention is described, with reference to the accompanying drawings.

### First Exemplary Embodiment

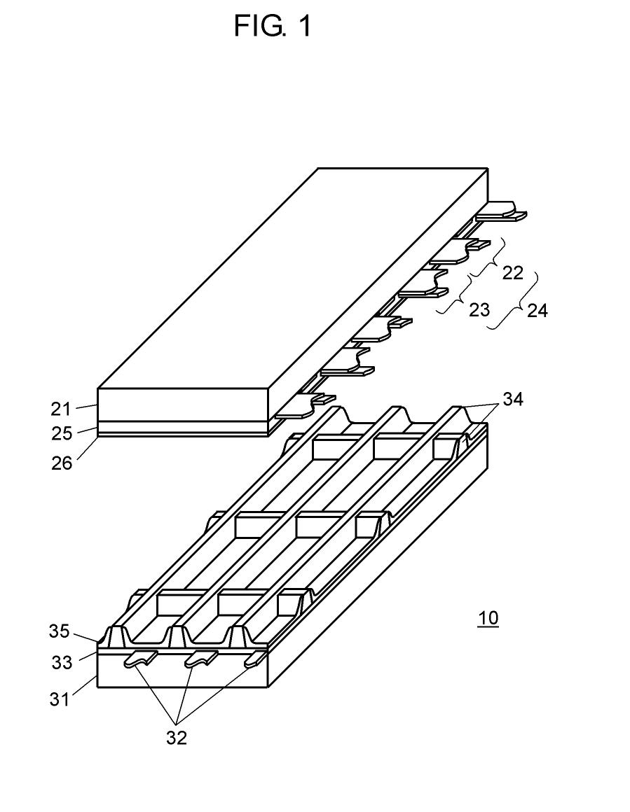

FIG. 1 is an exploded perspective view showing the structure of panel 10 for use in a plasma display apparatus in accordance with the first exemplary embodiments of the present invention. A plurality of display electrode pairs, each including scan electrode 22 and sustain electrode 23 is disposed on glass-made front substrate 21. Dielectric layer 25 is formed so as to cover scan electrodes 22 and sustain electrodes 23. Protective layer 26 is formed over dielectric layer 25.

Protective layer 26 is made of a material predominantly composed of magnesium oxide (MgO). The material is proven as being effective in decreasing a discharge start voltage in the discharge cells. Besides, the MgO-based material offers a large coefficient of secondary electron emission and high durability against discharge gas having neon (Ne) and xenon (Xe).

On rear substrate 31, a plurality of data electrodes 32 is disposed. Dielectric layer 33 is formed so as to cover data electrodes 32, and grid-like barrier ribs 34 are formed on the dielectric layer. On the side faces of barrier ribs 34 and on dielectric layer 33, phosphor layers 35 for emitting light of red color (R), green color (G), and blue color (B) are formed.

Front substrate 21 and rear substrate 31 are oppositely disposed to each other such that display electrode pairs 24 are positioned orthogonal to data electrodes 32 with a small discharge space sandwiched between the electrodes. The outer peripheries of the substrates are sealed with a sealing material, such as a glass frit. The inside of the discharge space is filled with discharge gas, for example, a mixed gas of neon and xenon. The discharge gas employed for the embodiment has a xenon partial pressure of approximately 15% so as to improve emission efficiency in the discharge cells.

Barrier ribs 34 divide the discharge space into a plurality of compartments in a way that each compartment has the intersecting part of display electrode pair 24 and data electrode 32. Discharge cells are thus formed at the intersecting parts of display electrode pairs 24 and data electrodes 32. The discharge cells have a discharge and emit light (light on) so as to display a color image on panel 10.

In panel 10, one pixel is formed by three successive discharge cells, a discharge cell for emitting light of red color (R), a discharge cell for emitting light of green color (G), and a discharge cell for emitting light of blue (B) color, arranged in the extending direction of display electrode pair 24. Hereinafter, a discharge cell that emits red light is referred to as an R discharge cell, a discharge cell that emits green light is referred to as a G discharge cell, and a discharge cell that emits blue light is referred to as a B discharge cell.

The structure of panel 10 is not limited to the above, and may include barrier ribs formed into stripes, for example. The mixture ratio of the discharge gas is not limited to the above numerical value, and other mixture ratios may be used. For example, the xenon partial pressure may be increased for enhancing emission efficiency.

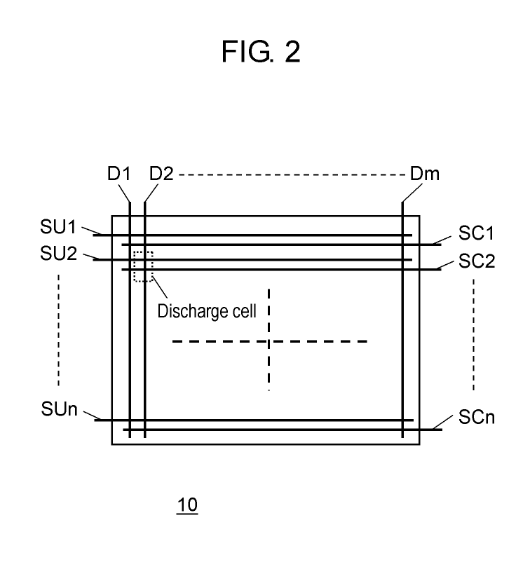

FIG. 2 is an electrode array diagram of panel 10 for use in the plasma display apparatus in accordance with the exemplary embodiment of the present invention. Panel 10 has n scan electrodes SC1 through SCn (that form scan electrodes 22 in FIG. 1) and n sustain electrodes SU1 through SUn (that form sustain electrodes 23 in FIG. 1) both extending in the horizontal (row) direction, and m data electrodes D1 through Dm (that form data electrodes 32 in FIG. 1) extending in the vertical (line) direction. A discharge cell is formed at the part where a pair of scan electrode SCi (i=1 to n) and sustain electrode SUi intersects one data electrode Dj (j=1 to m). That is, m discharge cells (i.e. m/3 pixels) are formed for each display electrode pair 24. In the discharge space, m×n discharge cells are formed. The area having m×n discharge cells is the image display area of panel 10. For example, in a panel having 1920×1080 pixels, m=1920×3 and n=1080. Although n=1080 in the embodiment, it is not to be construed as limiting value.

Next, the method of driving panel 10 of the plasma display apparatus of the exemplary embodiment will be described. The plasma display apparatus of the embodiment display gradations by a subfield method. In the subfield method, one field is divided into a plurality of subfields along a temporal axis, and a luminance weight is set for each subfield. Each of the subfields has an initializing period, an address period, and a sustain period. By controlling the light emission and no light emission in each discharge cell in each subfield, an image is displayed on panel 10.

The luminance weight represents a ratio of the magnitudes of luminance displayed in the respective subfields. In the sustain period of each subfield, sustain pulses corresponding in number to the luminance weight are generated. For example, the light emission in the subfield having the luminance weight “8” is approximately eight times as high as that in the subfield having the luminance weight “1”, and approximately four times as high as that in the subfield having the luminance weight “2”. Therefore, the selective light emission caused by the combination of the respective subfields in response to image signals allows the panel to display various gradations forming an image.

In this exemplary embodiment, one field is divided into ten subfields (subfield SF1, subfield SF2, . . . , subfield SF10). The luminance weight is determined in a way that a subfield that follows on a previous subfield in a temporally order has a luminance weight greater than that of the previous subfield. Respective subfields have luminance weights of 1, 2, 3, 6, 11, 18, 30, 44, 60, and 80. With the structure above, each of the R signal, the G signal, and the B signal is displayed in 256 gradation levels from 0 to 255.

In the initializing period of one subfield among a plurality of subfields, an all-cell initializing operation for causing an initializing discharge in all the discharge cells is performed. In the initializing periods of the other subfields, a selective initializing operation for causing an initializing discharge only in the discharge cells having undergone a sustain discharge in the sustain period of the immediately preceding sub field is performed. Hereinafter, the subfield having the all-cell initializing operation is referred to as an all-cell initializing subfield, while the subfield having the selective initializing operation is referred to as a selective initializing subfield.

In the embodiment, the description will be given on a case where subfield SF1 is the all-cell initializing subfield, and subfields SF2 through SF10 are the selective initializing subfields. With the structure above, the light emission with no contribution to image display is only the light emission caused by the discharge in the all-cell initializing operation in subfield SF1. That is, the display area of luminance of black where luminance of black is displayed due to no sustain discharge has only weak light emission caused by the all-cell initializing operation. Thereby, an image of high contrast can be displayed on panel 10.

In the sustain period of each subfield, sustain pulses based on the luminance weight of the corresponding subfield multiplied by a predetermined proportionality factor are applied to respective display electrode pairs 24. This proportionality factor is a luminance magnification.

In each sustain period, sustain pulses equal in number to the luminance weight of the corresponding subfield multiplied by a predetermined luminance magnification are applied to respective scan electrodes 22 and sustain electrodes 23. Therefore, when the luminance magnification is 2, in the sustain period of a subfield having a luminance weight of 2, each of scan electrode 22 and sustain electrode 23 undergoes four-time application of sustain pulses. That is, the number of sustain pulses generated in the sustain period of the subfield is 8.

However, in this exemplary embodiment, the number of subfields forming one field, or the luminance weights of the respective subfields is not limited to the above values. Alternatively, the subfield structure may be switched in response to an image signal, for example.

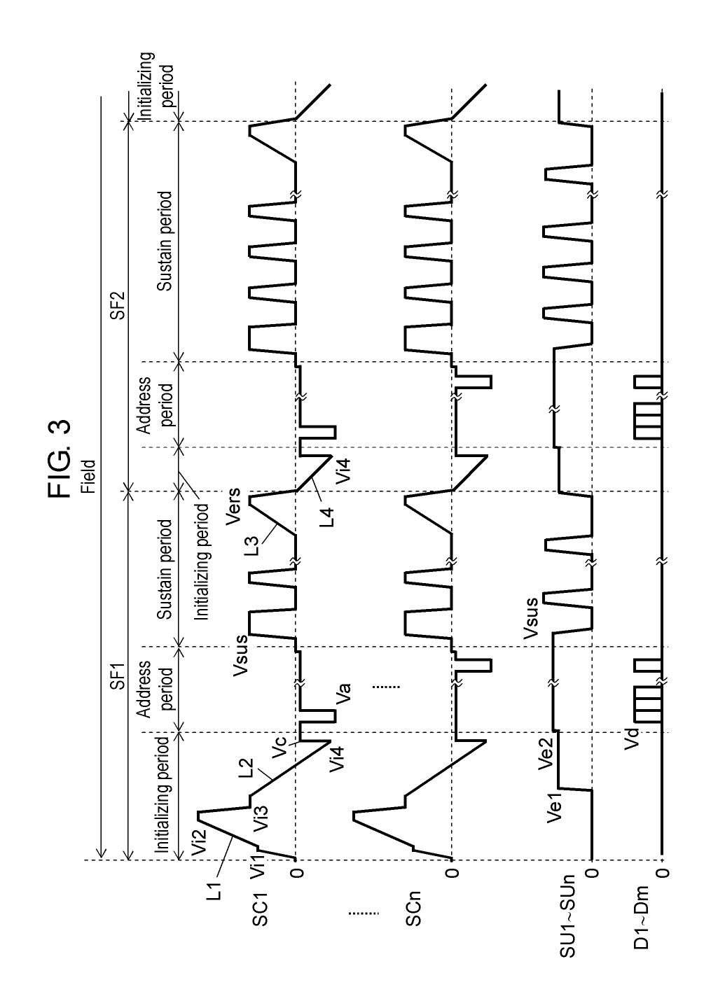

FIG. 3 is a chart of driving voltage waveforms applied to the respective electrodes of panel 10 for use in the plasma display apparatus in accordance with the exemplary embodiment of the present invention. Specifically, FIG. 3 shows driving voltage waveforms applied to scan electrode SC1 as the first scan electrode undergoes address operation in the address period, scan electrode SCn as the last scan electrode undergoes address operation in the address period, sustain electrodes SU1 through SUn, and data electrodes D1 through Dm.

It will also be noted that the driving voltage waveforms applied to scan electrodes SC1 through SCn in the initializing period are different between the two subfields shown in FIG. 3. In the two subfields, one is subfield SF1 as an all-cell initializing subfield, and the other is subfield SF2 as a selective initializing subfield. The driving voltage waveforms used for other subfields are similar to that of subfield SF2 except for the number of sustain pulses. Scan electrode SCi, sustain electrode SUi, and data electrode Dk in the following description are the electrodes selected from the respective electrodes, based on image data (i.e., data representing the light emission and no light emission in each subfield).

First, a description is provided for subfield SF1 as the all-cell initializing subfield.

In the first half of the initializing period of subfield SF1, voltage 0(V) is applied to data electrodes D1 through Dm, and sustain electrodes SU1 through SUn. Voltage Vi1 is applied to scan electrodes SC1 through SCn. Voltage Vi1 is set to a voltage lower than a discharge start voltage with respect to sustain electrodes SU1 through SUn. Further, a ramp voltage gently rising from voltage Vi1 toward voltage Vi2 is applied to scan electrodes SC1 through SCn. Hereinafter, the ramp voltage is referred to as up-ramp voltage L1. Voltage Vi2 is set to a voltage exceeding the discharge start voltage with respect to sustain electrodes SU1 through SUn. For example, the voltage gradient of up-ramp voltage L1 may be set to approximately 1.3V/μsec.

While up-ramp voltage L1 is increasing, a weak initializing discharge continuously occurs between scan electrodes SC1 through SCn and sustain electrodes SU1 through SUn, and between scan electrodes SC1 through SCn and data electrodes D1 through Dm. Through the discharge, negative wall voltage accumulates on scan electrodes SC1 through SCn, and positive wall voltage accumulates on data electrodes D1 through Dm and sustain electrodes SU1 through SUn. This wall voltage on the electrodes means voltages that are generated by the wall charge accumulated on the dielectric layers covering the electrodes, the protective layer, the phosphor layers, or the like.

In the second half of the initializing period, positive voltage Ve1 is applied to sustain electrodes SU1 through SUn, and voltage 0(V) is applied to data electrodes D1 through Dm. A ramp voltage gently falling from voltage Vi3 to negative voltage Vi4 is applied to scan electrodes SC1 through SCn. Hereinafter, the ramp voltage is referred to as down-ramp voltage L2. Voltage Vi3 is set to a voltage lower than the discharge start voltage with respect to sustain electrodes SU1 through SUn, and voltage Vi4 is set to a voltage exceeding the discharge start voltage. For example, the voltage gradient of down-ramp voltage L2 may be set to approximately −2.5V/μsec.

While down-ramp voltage L2 is applied to scan electrodes SC1 through SCn, a weak initializing discharge occurs between scan electrodes SC1 through SCn and sustain electrodes SU1 through SUn, and between scan electrodes SC1 through SCn and data electrodes D1 through Dm. This weak discharge reduces the negative wall voltage on scan electrodes SC1 through SCn and the positive wall voltage on sustain electrodes SU1 through SUn, and adjusts the positive wall voltage on data electrodes D1 through Dm to a value appropriate for the address operation. In this manner, the all-cell initializing operation for causing an initializing discharge in all the discharge cells is completed.

Hereinafter, the period having an all-cell initializing operation is referred to as an all-cell initializing period. Similarly, the driving voltage waveform for causing an all-cell initializing operation is referred to as an all-cell initializing waveform.

In the subsequent address period, a scan pulse of voltage Va is sequentially applied to scan electrodes SC1 through SCn. As for data electrodes D1 through Dm, an address pulse of positive voltage Vd is applied to data electrode Dk disposed at a discharge cell to be lit. Application of voltage above generates an address discharge selectively in the discharge cells.

Specifically, first, voltage Vet is applied to sustain electrodes SU1 through SUn, and voltage Vc is applied to scan electrodes SC1 through SCn.

Next, a scan pulse of negative voltage Va is applied to scan electrode SC1 in the first row that firstly undergoes the address operation. At the same time, an address pulse of positive voltage Vd is applied to data electrode Dk of a discharge cell to be lit in the first row in data electrodes D1 through Dm. Through the application of the pulses, the voltage difference in the intersecting part of data electrode Dk and scan electrode SC1 is calculated by adding the difference between the wall voltage on data electrode Dk and the wall voltage on scan electrode SC1 to the externally applied voltage difference (=voltage Vd−voltage Va). In this way, the voltage difference between data electrode Dk and scan electrode SC1 exceeds the discharge start voltage, generating a discharge between the two electrodes above.

As described above, voltage Ve2 is applied to sustain electrodes SU1 through SUn. Through the application of the voltage, the voltage difference between sustain electrode SU1 and scan electrode SC1 is calculated by adding the difference between the wall voltage on sustain electrode SU1 and the wall voltage on scan electrode SC1 to the externally applied voltage difference (=voltage Ve2−voltage Va). At this time, by setting voltage Ve2 at a voltage value just below the discharge start voltage, a “discharge-prone” state just before an actual discharge generation is formed between sustain electrode SU1 and scan electrode SC1.

The discharge generated between data electrode Dk and scan electrode SC1 triggers a discharge between sustain electrode SU1 and scan electrode SC1 that are disposed in the area intersecting to data electrode Dk. Thus, an address discharge occurs in the discharge cell to be lit. Positive wall voltage accumulates on scan electrode SC1, and negative wall voltage accumulates on sustain electrode SU1 and on data electrode Dk.

In this manner, address operation is performed to cause an address discharge in the discharge cells to be lit in the first row and to accumulate wall voltage on the respective electrodes. In contrast, because of no application of address pulses, the voltage of the intersecting part of scan electrode SC1 and data electrodes 32 does not exceed the discharge start voltage; accordingly, no address discharge occurs.

In a similar way, the address operation is sequentially performed. On the completion of the address operation on the discharge cells in the n-th row, the address period is over. In the address period, as described above, an address discharge is selectively generated in a discharge cell to be lit, and wall charge is formed in the discharge cell.

In the subsequent sustain period, voltage 0(V) is applied to sustain electrodes SU1 through SUn, and at the same time, sustain pulses of positive voltage Vsus are applied to scan electrodes SC1 through SCn. In the discharge cells having undergone the address discharge, the voltage difference between scan electrode SCi and sustain electrode SUi is calculated by adding the difference between the wall voltage on scan electrode SCi and the wall voltage on sustain electrode SUi to sustain pulse voltage Vsus.

Thus, the voltage difference between scan electrode SCi and sustain electrode SUi exceeds the discharge start voltage and a sustain discharge occurs between scan electrode SCi and sustain electrode SUi. Ultraviolet rays generated by this discharge cause phosphor layers 35 to emit light. With this discharge, negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs and the wall voltage at the completion of the initializing period is maintained.

Subsequently, voltage 0(V) is applied to scan electrodes SC1 through SCn, and sustain pulses of voltage Vsus are applied to sustain electrodes SU1 through SUn. In the discharge cells having undergone the sustain discharge, the voltage difference between sustain electrode SUi and scan electrode SCi exceeds the discharge start voltage. Thereby, a sustain discharge occurs again between sustain electrode SUi and scan electrode SCi. Negative wall voltage accumulates on sustain electrode SUi, and positive wall voltage accumulates on scan electrode SCi.

Similarly, sustain pulses are alternately applied to scan electrodes SC1 through SCn and sustain electrodes SU1 through SUn. The number of sustain pulses applied to the electrodes above corresponds to a number calculated by multiplying the luminance weight by a predetermined luminance magnification. The application of sustain pulses above continuously generates a sustain discharge in the discharge cells having undergone the address discharge in the address period.

After the sustain pulses have been generated in the sustain period, a ramp waveform voltage gently rising from voltage 0(V) toward voltage Vers is applied to scan electrodes SC1 through SCn while voltage 0(V) is applied to sustain electrodes SU1 through SUn and data electrodes D1 through Dm. Hereinafter, the ramp waveform voltage is referred to as erasing ramp voltage L3.

Erasing ramp voltage L3 has a gradient steeper than that of up-ramp voltage L1. The gradient of erasing ramp voltage L3 is set to, for example, approximately 10V/μsec. Determining voltage Vers so as to exceed the discharge start voltage generates a weak discharge between sustain electrode SUi and scan electrode SCi at a discharge cell having undergone a sustain discharge.

The weak discharge generates charged particles, which accumulate on sustain electrode SUi and scan electrode SCi so as to reduce the voltage difference between sustain electrode SUi and scan electrode SCi. Thereby, in the discharge cells having undergone the sustain discharge, the wall voltage on scan electrode SCi and sustain electrode SUi is partly or completely erased, while the positive wall voltage is left on data electrode Dk. That is, the discharge caused by erasing ramp voltage L3 serves as an erasing discharge, by which unnecessary wall charge accumulated in a discharge cell having undergone a sustain discharge is erased.

After the rising voltage applied to scan electrodes SC1 through SCn reached voltage Vers, the voltage is lowered to the base voltage, i.e., voltage 0(V). Thus, the sustain operation in the sustain period is completed.

The driving voltage waveform used in the initializing period of subfield SF2 differs from that used in subfield SF1 in that the first half of the waveform is omitted. In the initializing period of subfield SF2, voltage Ve1 is applied to sustain electrodes SU1 through SUn, and voltage 0(V) is applied to data electrodes D1 through Dm. A ramp waveform voltage, which is referred to as down-ramp voltage L4, is applied to scan electrodes SC1 through SCn. Down-ramp voltage L4 gently falls from a voltage lower than the discharge start voltage with respect to scan electrodes SC1 through SCn (e.g. voltage 0(V)) toward negative voltage Vi4 exceeding the discharge start voltage. The voltage gradient of down-ramp voltage L4 is, for example, approximately −2.5V/μsec.

With the application of voltage, a weak initializing discharge occurs in the discharge cells having undergone a sustain discharge in the sustain period of the immediately preceding subfield (i.e. subfield SF1 in FIG. 3). This weak discharge reduces the wall voltage on scan electrode SCi and sustain electrode SUi. The wall voltage accumulated on data electrode Dk is adjusted to a value appropriately for the address operation. In contrast, in the discharge cells having undergone no sustain discharge in the sustain period of the immediately preceding subfield, no initializing discharge occurs, and the wall charge at the completion of the initializing period of the immediately preceding subfield is maintained.

In this manner, in the initializing period of subfield SF2, a selective initializing operation is performed so as to selectively cause an initializing discharge in the discharge cells having undergone a sustain discharge in the sustain period of the immediately preceding subfield. Hereinafter, the period having a selective initializing operation is referred to as a selective initializing period.

The driving voltage waveforms applied to each electrode in the address period and the sustain period of subfield SF2 are nearly the same as those used in the address period and the sustain period of subfield SF1, except for the number of the sustain pulses. Further, the driving voltage waveforms applied to each electrode in other subfields after subfield SF3 are nearly the same as those used in subfield SF2, except for the number of the sustain pulses.

The description above has provided an overview of the driving voltage waveforms applied to the electrodes of panel 10 of the embodiment.

The voltage to be applied to the respective electrodes in this exemplary embodiment includes the following values: voltage Vi1=145(V); voltage Vi2=350(V); voltage Vi3=190(V); voltage Vi4=−160(V); voltage Va=−180(V); voltage Vsus=190(V); voltage Vers=190(V); voltage Ve1=125(V); voltage Ve2=125(V); and voltage Vd=60(V). Voltage Vc is determined by adding positive voltage Vscn (=145V) on negative voltage Va (=−180V); in that case, voltage Vc=−35(V). However, these voltage values are only examples. Preferably, each of the voltage values should be set appropriate for the characteristics of panel 10 and the specifications of the plasma display apparatus.

Next, the structure of the plasma display apparatus of the embodiment will be described.

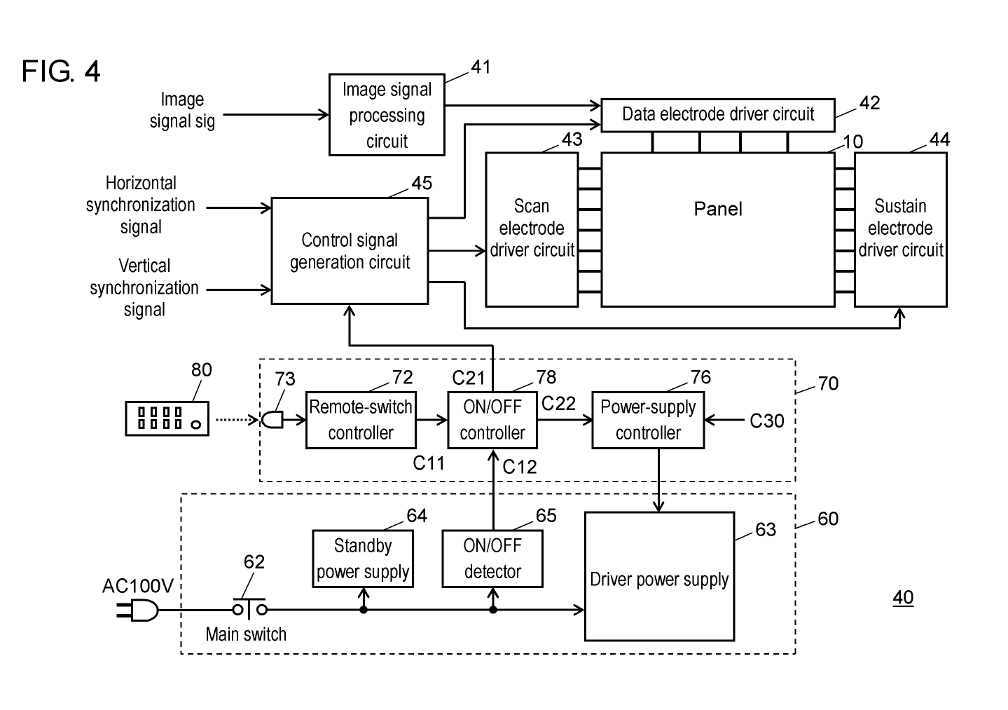

FIG. 4 is a circuit block diagram of plasma display apparatus 40 in accordance with the exemplary embodiment. Plasma display apparatus 40 has panel 10 and a driver circuit. The driver circuit includes image signal processing circuit 41, data electrode driver circuit 42, scan electrode driver circuit 43, sustain electrode driver circuit 44, control signal generation circuit 45, power supply circuit 60, and control circuit 70.

Image signal processing circuit 41 allocates gradation values to each discharge cell, based on input image signal sig. Image signal processing circuit 41 converts the gradation values into image data representing light emission or no light emission (where, light emission and no light emission correspond to ‘1’ and ‘0’, respectively, of digital signals) in each subfield.

For instance, when input image signal sig includes R signal, G signal, and B signal, R, G, and B gradation values are allocated to the respective discharge cells, based on the R signal, G signal, and B signal. When the input image signal includes luminance signal (Y signal) and chroma signal (C signal, R-Y signal and B-Y signal, u signal and v signal, or the like), the R signal, the G signal, and the B signal are calculated based on the luminance signal and the chroma signal, and thereafter the R, G, and B gradation values (gradation values represented in one field) are allocated to the respective discharge cells. Then, the R, G, and B gradation values allocated to the respective discharge cells are converted into image data representing light emission or no light emission in each subfield.

Based on a horizontal synchronization signal, a vertical synchronization signal, and output signal from on/off controller 78 of control circuit 70, control signal generation circuit 45 generates control signals for controlling the operation of each circuit block and supplies the generated control signals to respective circuit blocks (e.g. data electrode driver circuit 42, scan electrode driver circuit 43, sustain electrode driver circuit 44). In addition, control signal generation circuit 45 carries out operation for decreasing the initialization bright points for a predetermined period just after power-off of plasma display apparatus 40, according to enable signal C21, which will be described later.

Scan electrode driver circuit 43 has an initializing waveform generation circuit, a sustain pulse generation circuit, and a scan pulse generation circuit (not shown). Scan electrode driver circuit 43 drives scan electrodes SC1 through SCn, based on the control signals fed from control signal generation circuit 45. In response to the control signals, the initializing waveform generation circuit generates initializing waveforms to be applied to scan electrodes SC1 through SCn in the initializing period. In response to the control signals, the sustain pulse generation circuit generates sustain pulses to be applied to scan electrodes SC1 through SCn in the sustain period. The scan pulse generation circuit has a plurality of scan electrode driver ICs (scan ICs). In response to the control signals, the scan pulse generation circuit generates scan pulses to be applied to scan electrodes SC1 through SCn in the address period.

Sustain electrode driver circuit 44 has a sustain pulse generation circuit, and a circuit for generating voltage Ve1 and voltage Ve2 (not shown). Based on the control signals supplied from control signal generation circuit 45, sustain electrode driver circuit 44 drives sustain electrodes SU1 through SUn. In the sustain period, sustain electrode driver circuit 44 generates sustain pulses in response to the control signals and applies the sustain pulses to sustain electrodes SU1 through SUn.

Data electrode driver circuit 42 converts data that forms image data for each subfield into signals corresponding to each of data electrodes D1 through Dm. Based on the converted signal and the control signals fed from control signal generation circuit 45, data electrode driver circuit 42 drives data electrodes D1 through Dm. In the address period, data electrode driver circuit 42 generates address pulses according to the control signal, and applies them to data electrodes D1 through Dm.

Power supply circuit 60 has main switch 62, driver power supply 63 as a power source for each circuit block that drives panel 10, standby power supply 64 as a power source for driving control circuit 70, and on/off detector 65. When main switch 62 is turned on, electric power is fed from power supply of ordinary household (e.g. 100V AC) into the circuits in power supply circuit 60. On/off detector 65 outputs a signal indicating whether main switch 62 is on or off (i.e., power-on signal C12).

Turning on main switch 62 establishes electrical connection between household power supply and plasma display apparatus 40, allowing electric power to be fed from household power supply into standby power supply 64, on/off detector 65, and driver power supply 63, by which standby power supply 64 and on/off detector 65 start working. Standby power supply 64 provides control circuit 70 with electric power, and on/off detector 65 outputs power-on signal C12 indicating that main switch 62 is in the on state. The on/off (operating/non-operating) state of driver power supply 63 is controlled by power supply controller 76 of control circuit 70.

Standby power supply 64 and control circuit 70 are electrically connected so that electrical power is fed from standby power supply 64 to control circuit 70 by a power-supply line (not shown in FIG. 4). Similarly, driver power supply 63 and each circuit block are electrically connected so that electrical power is fed from driver power supply 63 to each circuit block by a power-supply line (not shown in FIG. 4).

Control circuit 70 has remote-switch signal receiver 73, remote-switch controller 72, on/off controller 78, and power-supply controller 76. Remote-switch signal receiver 73 receives a signal (e.g. an infrared signal) fed from remote control switch 80 (hereinafter, remote switch 80). Receiving the signal from remote-switch signal receiver 73, remote-switch controller 72 encodes it. On/off controller 78 effects on/off control of plasma display apparatus 40 in response to output signals of on/off detector 65 and remote-switch controller 72.

Receiving a signal (e.g. an infrared signal) fed from remote switch 80, remote-switch signal receiver 73 converts the signal into an electric signal and outputs the signal.

Receiving the signal fed from remote-switch signal receiver 73, remote-switch controller 72 finds instruction set in the signal fed from remote-switch signal receiver 73 (i.e. encodes the signal) and converts it into control signals. The control signals includes on-signal C11 that effects on/off control of power of plasma display apparatus 40. That is, remote-switch controller 72 receives the signal from remote switch 80 via remote-switch signal receiver 73, and generates on-signal C11.

According to on-signal C11 and power-on signal C12, on/off controller 78 generates enable signal C21 used for operation control of control signal generation circuit 45. Enable signal C21 is transmitted to control signal generation circuit 45. Besides, on/off controller 78 generates enable signal C22 used for on/off control of driver power supply 63. Enable signal C22 is transmitted to power-supply controller 76.

Receiving enable signal C21, control signal generation circuit 45 carries out operation for decreasing the initialization bright points for a predetermined period just after plasma display apparatus 40 turned off. Hereinafter, the predetermined period just after power-off of apparatus 40 is referred to an off-preparation period. The “turned-off” apparatus above specifically means the following state. That is, remote switch 80 transmits a turn-off signal in response to the user's operation. Receiving the turn-off signal, remote-switch controller 72 determines on-signal C11 to be off.

Receiving enable signal C22, power-supply controller 76 effects on/of control of driver power supply 63. In addition, if receiving emergency strop signal 30 that indicates an abnormal state of plasma display apparatus 40, power-supply controller 76 stops driver power supply 63.

Control circuit 70 is formed of, for example, microcomputers.

Next, the off-preparation period in the exemplary embodiment will be described.

As described above, increase in xenon partial pressure for enhancing emission efficiency of panel 10 increases discharge delay. In application of up-ramp voltage L1 for the all-cell initializing operation, the voltage applied to the discharge cells continues to increase after exceeding a discharge start voltage. Increase in discharge delay means increase in time lag between actual generation of discharge and application of voltage exceeding the discharge start voltage. That is, the voltage applied to the discharge cells has further increased by the time a discharge actually occurs, so that a strong discharge is easily generated in the discharge cells. Such a strong discharge forms an excessive amount of wall charge, which can induce a false discharge in the discharge cell in the successive address operation. As a result, the discharge cell has a sustain discharge in spite of no addressing, causing unintended light emission. The initialization bright points are thus generated in panel 10.

When plasma display apparatus 40 is turned on and each driver circuit starts working, panel 10 changes from the non-operating state into the operating state. In the early stage of the operating state, i.e. at the start of operation of panel 10, priming particles are not enough in the discharge cells. The poor amount of the priming particles causes increase in discharge delay. From the reason above, the strong discharge easily occurs in the all-cell initializing operation in panel 10 of plasma display apparatus 40 at the start of operation.

In panel 10 with high emission efficiency by increase in xenon partial pressure, as described above, initialization bright points are easily generated in panel 10 just after power-on of plasma display apparatus 40. The initialization bright points are unintended emission with no regard to image signals, which degrades the quality of display image.

The inventor confirmed the following about a relation between the strong discharge and the state of the panel; the strong discharge generated at the all-cell initializing operation in panel 10 just after power-on of plasma display apparatus 40 is affected by the light-on state of panel 10 just before power-off of the apparatus. Specifically, the discharge cell that has lit on just before power-off of the apparatus easily has a strong discharge at the all-cell initializing operation in panel 10 just after power-on of the apparatus. It is considered that the phenomenon is led by the following.

When application of driving voltage is suddenly stopped in response to power-off of the apparatus, in a discharge cell having undergone a sustain discharge just before the power-off, a large amount of priming particles produced by the sustain discharge are floating in the discharge cell. At the same time, in the discharge cell, the MgO surface maintains an active state by the sustain discharge, continuously releasing exo-electrons (i.e., exo-electron mission).

With no application of driving voltage due to the power-off, the discharge cell rapidly loses electric field retained therein, and a large amount of priming particles form abnormal wall charge in the discharge cell. The abnormally built wall charge is considered to induce a strong discharge at the all-cell initializing operation in panel 10 at the start of operation of plasma display apparatus 40.

Further, the inventor found another relation between the strong discharge and the state of the panel. That is, when all the image display area of panel 10 is in the light-off state (for example, panel 10 shows black in all the area) just before power-off of plasma display apparatus 40, generation of strong discharge is decreased at all-cell initializing operation in panel 10 just after power-on of the apparatus.

It is considered that the decrease in generation of strong discharge is led by the reason below. When all the display area of panel 10 is in the light-off state just before power-off of the apparatus, the discharge cells have no sustain discharge before the power-off. In that case, the discharge cells retain priming particles smaller in amount than those of discharge cells having undergone a sustain discharge just before the power-off. At the same time, the MgO surface has a less amount of exo-electron emission.

Taking the above into consideration, the structure of the embodiment employs an off-preparation period to decrease the initialization bright points easily generated just after power-on of plasma display apparatus 40. The off-preparation period covers the length of time from power-off of plasma display apparatus 40 (i.e. from turned-off enable signal C21) until a complete stop of driving voltage applied to panel 10.

During the off-preparation period, a field that is formed of the subfields with no addressing is repeated predetermined number of times. In other words, during the off-preparation period, a field for showing black all the area of panel 10 is repeated predetermined number of times.

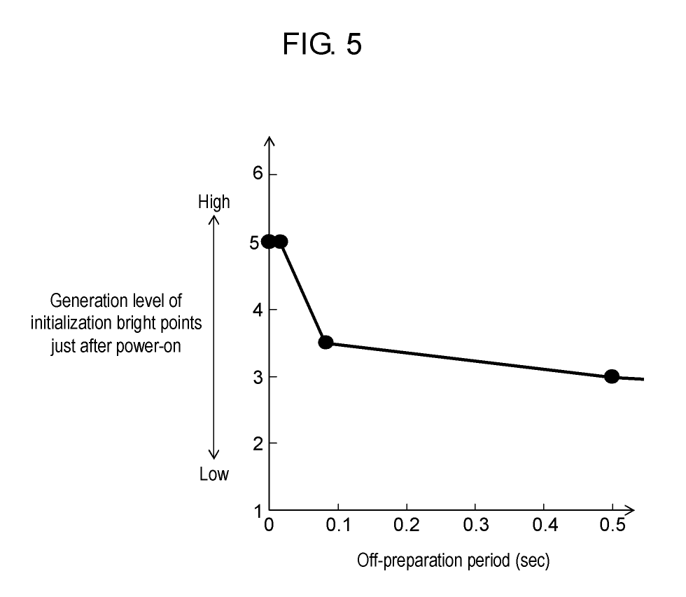

FIG. 5 is a graph showing the relation between a generation level of the initialization bright points just after power-on of plasma display apparatus 40 and the length of the off-preparation period in accordance with the first exemplary embodiment. In FIG. 5, the horizontal axis represents the length of the off-preparation period. The vertical axis represents the generation level of the initialization bright points (as a score obtained by estimator's visual observation) in panel 10 just after power-on of plasma display apparatus 40. In the graph, the larger in amount the initialization bright points generate, the higher the score.

As shown in FIG. 5, employing the off-preparation period apparently decreases the initialization bright points generated just after power-on of plasma display apparatus 40. It is considered that the priming particles in the discharge cells decrease and exo-electron emission from the MgO surface also decreases in the off-preparation period.

The off-preparation period should preferably be determined so as to have a sufficient length for decreasing the priming particles and the exo-electron emission. However, it is apparent from FIG. 5 that the effect on decreasing the initialization bright points become saturated as the length of the off-preparation period increases. Considering the above, there is no need for excessively lengthened period. That is, the off-preparation period should preferably be determined so as to have enough length to effectively decrease the initialization bright points at power-on time.

The inventor's experiment has shown that effective decrease in the initialization bright points at power-on time can be obtained by the off-preparation period having at least six fields. Considering the result, the off-preparation period is determined to have a length of six fields in the embodiment. However, the value is cited merely by way of example and the present invention is not limited to the value. The length of the off-preparation period should be set optimally for the characteristics of panel 10 and the specifications of the plasma display apparatus.

According to the structure of the embodiment, as described above, the off-preparation period is disposed between the power-off time (at which enable signal C21 is turned off) and complete stop of application of driving voltage to panel 10. The structure above effectively decreases the initialization bright points easily generated in panel 10 just after power-on of plasma display apparatus 40.

Next, the structure of scan electrode driver circuit 43 is described.

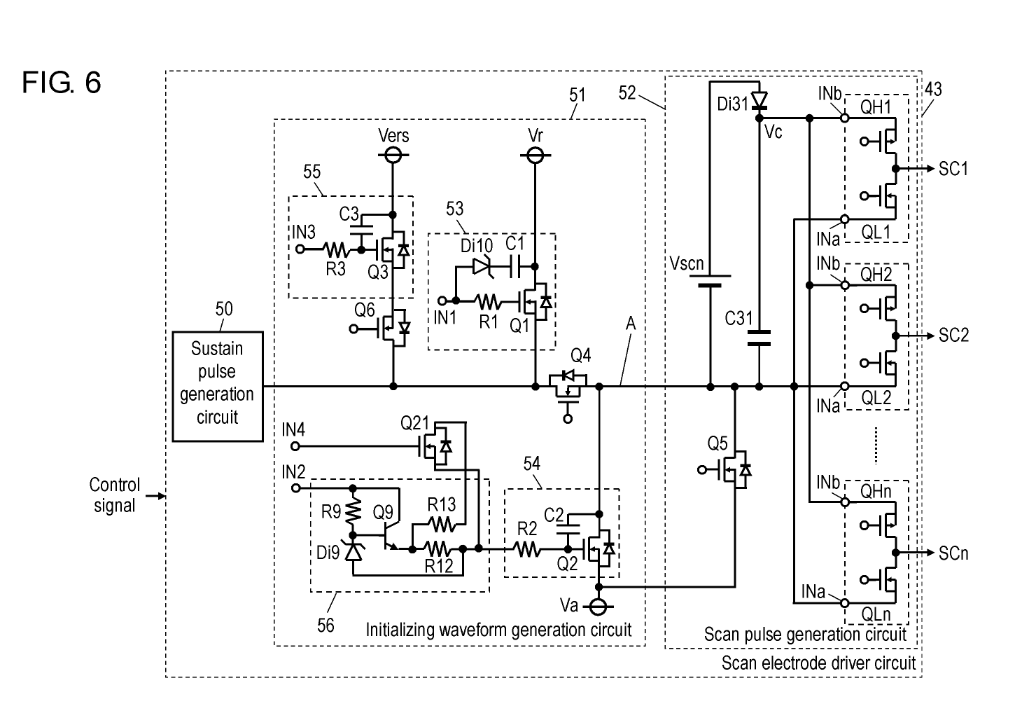

FIG. 6 is a circuit diagram showing the structure of scan electrode driver circuit 43 of plasma display apparatus 40 in accordance with the first exemplary embodiment. Scan electrode driver circuit 43 has sustain pulse generations circuit 50 disposed on the side of scan electrodes 22, initializing waveform generation circuit 51, and scan pulse generation circuit 52. Each of the output terminals of scan pulse generation circuit 52 is connected to scan electrodes SC1 through SCn of panel 10 so as to apply scan pulses separately to each of scan electrodes 22 in the address period.

In the embodiment, for the sake of convenience, the voltage fed into scan pulse generation circuit 52 is referred to reference potential A. Hereinafter, operating a switching element so as to establish electrical connections is represented by “turning on a switching element” and operating a switching element so as to break electrical connections is represented by “turning off a switching element”. Further, the signal that turns on a switching element is referred to signal Hi, and the signal that turns off a switching element is referred to signal Lo. A detailed signal path of control signals is not shown in FIG. 6.

FIG. 6 shows a separation circuit employing switching element Q4. When a circuit using negative voltage Va (e.g., Miller integration circuit 54) is in operation, operating switching element Q4 allows the circuit above to electrically separate from sustain pulse generation circuit 50, a circuit using voltage Vr (e.g., Miller integration circuit 53), and a circuit using voltage Vers (e.g., Miller integration circuit 55). FIG. 6 also shows a separation circuit employing switching element Q6. When a circuit using voltage Vr (e.g., Miller integration circuit 53) is in operation, operating switching element Q6 allows the circuit above to electrically separate from a circuit (e.g., Miller integration circuit 55) using voltage Vers that is lower than voltage Vr.

Sustain pulse generation circuit 50 has an ordinary power recovery circuit and a clamping circuit (not shown). The power recovery circuit has a power-recovery capacitor and a resonance inductor. Rise and decay of sustain pulses are obtained by LC resonance of inter-electrode capacitance of panel 10 and the inductor. The clamping circuit clamps reference potential A not only to voltage 0(V) as the base potential but also to voltage Vsus. In response to the control signal fed from control signal generation circuit 45, sustain pulse generation circuit 50 switches the operation between the power recovery circuit and the clamping circuit, allowing reference potential A fed into sustain electrode driver circuit 52 to set to voltage Vsus or to the ground potential i.e. voltage 0(V). The sustain pulses are thus generated.

Sustain electrode driver circuit 44 (not shown) has a sustain pulse generation circuit with a structure similar to sustain pulse generation circuit 50. In response to the control signal fed form control signal generation circuit 45, the sustain pulse generation circuit switches the switching elements disposed therein and generates sustain pulses. The sustain pulses are applied to n sustain electrodes (sustain electrodes SU1 through SUn).

Scan pulse generation circuit 52 has switching element Q5, power supply VSCN, diode Di31, capacitor C31, switching elements QH1 through QHn, and switching elements QL1 through QLn. Switching element Q5 connects reference potential A to negative voltage Va. Power supply VSCN generates voltage Vc that is obtained by adding voltage Vscn on reference potential A. Switching elements QH1 through QHn apply voltage Vc to each of scan electrodes SC1 through SCn, whereas switching elements QL1 through QLn apply reference potential A to each of scan electrodes SC1 through SCn.

Switching elements QH1 through QHn and QL1 through QLn are grouped by output and formed into ICs (i.e., scan ICs). Scan pulse generation circuit 52 has scan ICs for generating scan pulses to be applied to scan electrodes SC1 through SCn. As described above, forming many switching elements (switching elements QH1 through QHn and QL1 through QLn) into ICs allows the circuit structure to be compact, decreasing the area occupied by the circuits on the printed-circuit board. Besides, the structure contributes to cost-reduced production of plasma display apparatus 40.

Each input terminal INb of switching elements QH1 through QHn is connected to voltage Vc, whereas each input terminal INa of switching elements QL1 through QLn is connected to reference potential A.

In scan pulse generation circuit 52 structured above, switching element Q5 is turned on in an address period so that reference potential A is connected to negative voltage Va. Through the switching control, negative voltage Va is applied to input terminal INa, while voltage Vc (=voltage Va+voltage Vscn) is applied to input terminal INb. In addition, according to the control signal fed from control signal generation circuit 45, scan electrodes undergo application of voltage by the following switching control. As for scan electrode SCi to which a scan pulse is applied, a scan pulse of negative voltage Va is applied to the electrode via switching element QLi by turning off switching element QHi and turning on switching element QLi. As for scan electrode SCh (where, h takes 1 to n except for i) to which no scan pulse is applied, where, h takes 1 to n except for i), voltage Va+voltage Vscn is applied to the electrode via switching element QHh by turning off switching element QLh and turning on switching element QHh.

Initializing waveform generation circuit 51 has Miller integration circuits 53, 54, 55 and constant current generation circuit 56. Miller integration circuits 53 and 55 are the up-ramp voltage generation circuits for generating voltage having an up-ramp waveform, whereas Miller integration circuit 54 is the down-ramp voltage generation circuit for generating voltage having a down-ramp waveform. In FIG. 6, the input terminal of Miller integration circuit 53 is shown as input terminal IN1, the input terminal of Miller integration circuit 55 is shown as input terminal IN3, and the input terminal of constant current generation circuit 56 is shown as input terminal IN2.

Miller integration circuit 53 has switching element Q1, capacitor C1, resistor R1, and zener diode Di10 connected in series to capacitor C1. With the structure above, Miller integration circuit 53 raises reference potential A of scan electrode driver circuit 43 to voltage Vi2 with a moderate gradient of (for example, 1.3V/μsec) so as to generate up-ramp voltage L1 in an initializing operation. Zener diode Di10 generates voltage Vi1 by adding zener voltage (e.g. 45V) onto voltage Vscn in the initializing operation in the initializing period of SF1). That is, the starting voltage (from which the ramp voltage starts to rise) of up-ramp voltage L1 is set to voltage Vi1 by zener diode Di10. The zener voltage of zener diode Di10 has a voltage that is added on reference potential A.

Voltage Vr may be determined to be equivalent to voltage Vi2. As another possible setting, voltage Vi2 may be set to a voltage added voltage Vr on voltage Vscn. In that case, while up-ramp voltage L1 is being generated, switching elements QH1 through QHn are turned on and switching elements QL1 through QLn are turned off. Through the switching control above, a voltage obtained by adding the output voltage from initializing waveform generation circuit 51 on voltage Vscn can be applied to scan electrodes SC1 through SCn via switching elements QH1 through QHn.

Miller integration circuit 55 has switching element Q3, capacitor C3, and resistor R3. With the structure above, at the end of a sustain period, Miller integration circuit 55 raises reference potential A, with a gradient steeper than that of up-ramp voltage L1 (e.g. 10V/μsec), to voltage Vers so as to generate erasing ramp voltage L3.

Miller integration circuit 54 has switching element Q2, capacitor C2, and resistor R2. With the structure above, in an initializing operation, Miller integration circuit 54 moderately lowers (with a gradient of −2.5V/μsec, for example,) reference potential A down to voltage Vi4 so as to generate down-ramp voltage L2 and down-ramp voltage L4.

Constant current generation circuit 56 has transistor Q9, resistor R9, zener diode Di9, and resistor R12. The collector of transistor Q9 is connected to input terminal IN2. Resistor R9 is disposed between input terminal IN2 and the base of transistor Q9. Zener diode Di9 has the cathode connected to resistor R9 and the anode connected to resistor R2. Resistor R12 is disposed in series between the emitter of transistor Q9 and resistor R2. With application of a voltage (e.g. 5V) to input terminal IN2, constant current generation circuit 56 generates constant current and sends it to Miller integration circuit 54. While receiving the constant current, Miller integration circuit 54 lowers reference potential A.

Initializing waveform generation circuit 51 of the embodiment contains switching element Q21 having input terminal IN4 as a gate. Switching element 21 turns on in response to a control signal of Hi (e.g. 5V) applied to input terminal IN4, and it turns off in response to a control signal of Lo (e.g. 0V) applied to input terminal IN4. Constant current generation circuit 56 of the embodiment further contains resistor R13. Through the switching operation of switching element Q21, resistor R13 changes the current value of the constant current fed from constant current generation circuit 56. Specifically, one terminal of resistor R13 is connected to the connecting point of resistor R12 and transistor Q9, and the other terminal thereof is connected to the drain of switching element Q21. The source of switching element Q21 is connected to the connecting point of resistor R12 and resistor R2. With the structure above, turning on switching element Q21 establishes electrical connections of resistor R12 and resistor R13 in parallel. Compared to the off-state of switching element Q21, constant current generation circuit 56 has an increased output value of constant current, and Miller integration circuit 54 has an increased gradient of the ramp waveform voltage in the on-state of switching element Q21.

The structure above allows Miller integration circuit 54 to generate two ramp waveform voltages having difference in gradient.

The signals for controlling each circuit are fed from control signal generation circuit 45.

Control signal generation circuit 45 effects control of scan pulse generation circuit 52 in a manner so as to output, in an initializing period, the voltage waveform fed from initializing waveform generation circuit 51 and so as to output, in a sustain period, the voltage waveform fed from sustain pulse generation circuit 50. That is, while initializing waveform generation circuit 51 or sustain pulse generation circuit 50 is in operation, switching elements QH1 through QHn are turned off and switching elements QL1 through QLn are turned on in scan pulse generation circuit 52. Through the switching control, an initializing waveform or a sustain pulse is applied to scan electrodes SC1 through SCn via switching elements QL1 through QLn. When the voltage obtained by adding voltage Vscn on the output voltage from initializing waveform generation circuit 51 is applied to scan electrodes SC1 through SCn, switching elements QH1 through QHn are turned on and switching element QL1 through QLn are turned off. Through the switching control, an initializing waveform is applied to scan electrodes SC1 through SCn via switching elements QH1 through QHn.

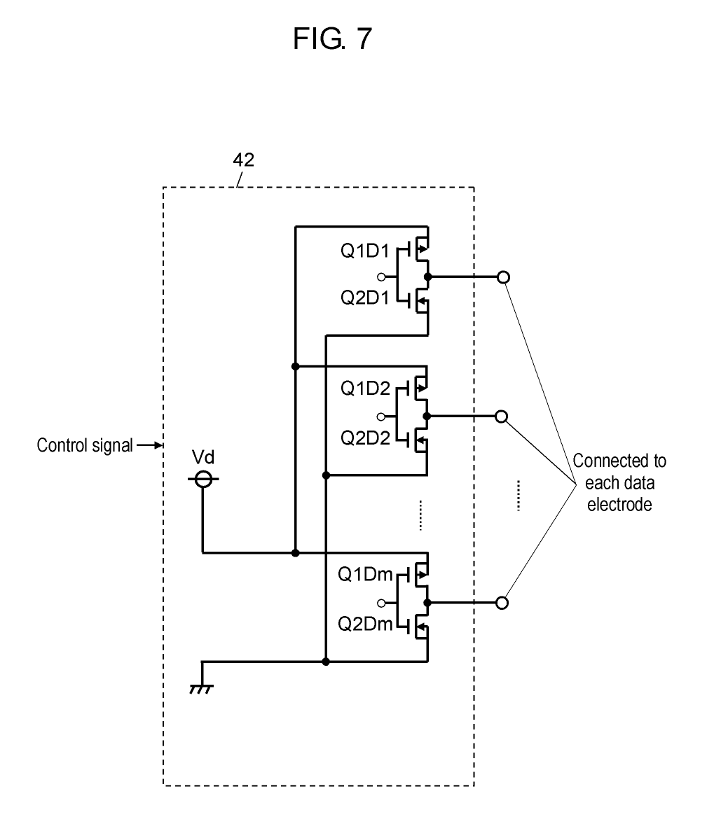

FIG. 7 is a circuit diagram showing the structure of data electrode driver circuit 42 of plasma display apparatus 40 of the first exemplary embodiment. Data electrode driver circuit 42 has switching elements Q1D1 through Q1Dm and switching elements Q2D1 through Q2Dm.

In data electrode driver circuit 42, the control of switching elements Q1D1 through Q1Dm allows the voltage to be applied to scan electrodes 32 to be separately clamped to voltage Vd. Similarly, the control of switching elements Q2D1 through Q2Dm allows the voltage to be applied to scan electrodes 32 to be separately grounded (i.e., clamped to 0V). In this way, data electrode driver circuit 42 separately drives data electrodes 32 and applies positive address pulses of voltage Vd to the electrodes.

According to a control signal fed from control signal generation circuit 45, data electrode driver circuit 42 effects control of switching elements Q1D1 through Q1Dm and switching elements Q2D1 through Q2Dm so as not to generate address pulses during the off-preparation period, by which panel 10 shows black throughout the display area (because of no sustain discharge in the discharge cells).

According to the structure of the embodiment, as described above, the off-preparation period is disposed between the power-off time (at which enable signal C21 is turned off) and complete stop of application of driving voltage to panel 10. No generation of address pulses during the off-preparation period allows panel 10 to show black throughout the display area (i.e., to have no sustain discharge). The structure above effectively decreases the initialization bright points easily generated in panel 10 just after power-on of plasma display apparatus 40.

### Second Exemplary Embodiment

In the structure described in the first exemplary embodiment, no generation of address pulses during the off-preparation period allows panel 10 to show black throughout the display area (i.e., to have no sustain discharge).

In the structure above, in addition to the address pulses, the scan pulses and the sustain pulses can be also stopped with no adverse effect. Further, down-ramp voltage L4 (for generating an initializing discharge by a selective-cell initializing operation) can be stopped with no adverse effect.

In the off-preparation period of the embodiment, all of the address pulses, the scan pulses, the sustain pulses, and down-ramp voltage L4 are stopped. Only all-cell initializing operation is performed.

Compared to the normal operation state where panel 10 is driven on the image signals, the period during which the address pulses, the scan pulses, the sustain pulses, and down-ramp voltage L4 are stopped can be determined to be shorter. That is, when only the all-cell initializing operation is performed in the off-preparation period, the period between all-cell initializing operations can be determined to be shorter than that in the normal operation state (i.e., to be shorter than one field period).

For example, in the normal operation state where plasma display apparatus 40 is driven on an image signal of 60 Hz, the length of one field measures approximately 16 msec; in the state above, the period between the all-cell initializing operations has a length of approximately 16 msec. In the off-preparation period of the embodiment, however, the period between the all-cell initializing operations can be shortened (to approximately 3 msec, for example).

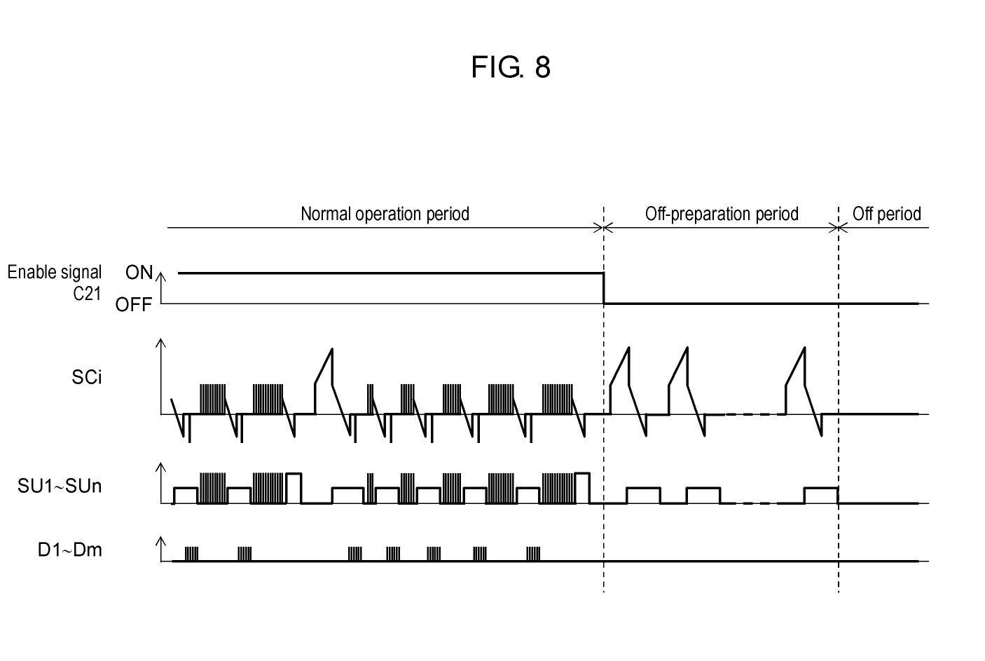

FIG. 8 is a chart of driving voltage waveforms to be applied to the electrodes (i.e., scan electrode SCi, sustain electrodes SU1 through SUn, and data electrodes D1 through Dm) of panel 10 in the off-preparation period in accordance with a second exemplary embodiment. FIG. 8 also shows enable signal C21.

In response to on-signal C11 fed from remote-switch controller 72, on/off controller 78 switches enable signal C21 between on and off. Receiving turned-off enable signal C21, control signal generation circuit 45 changes the control signal so that the normal operation is switched into the operation of the off-preparation period.

In the off-preparation period of the embodiment, as shown in FIG. 8, the address pulses, the scan pulses, the sustain pulses, and down-ramp voltage L4 are all stopped, and only the all-cell initializing operation (in the initializing period of subfield SF1 shown in FIG. 3) is repeated predetermined number of times. The period between the all-cell initializing operations has a length of approximately 3 msec, which is shorter than that of a period in the normal operation.

On completion of the off-preparation period, plasma display apparatus 40 stops generation of all the driving voltage waveforms (as shown as “off period” in FIG. 8).

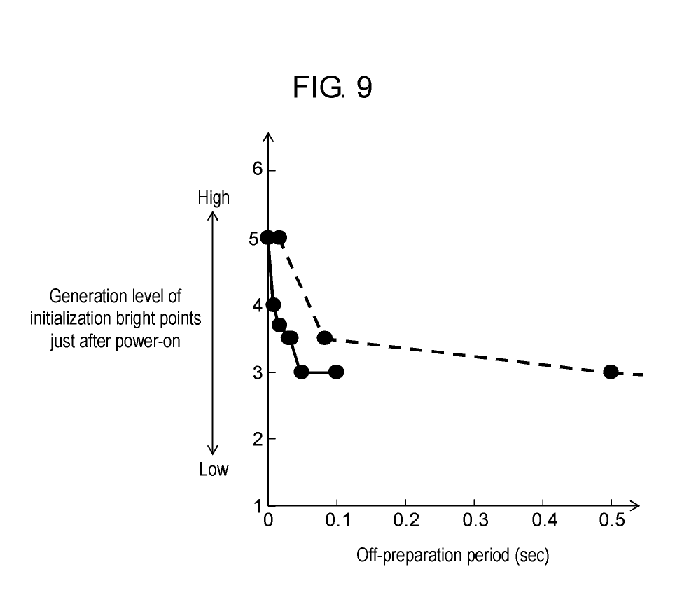

FIG. 9 is a graph showing the relation between a generation level of the initialization bright points on panel 10 just after power-on of plasma display apparatus 40 and the length of the off-preparation period in accordance with the second exemplary embodiment. In FIG. 9, the horizontal axis represents the length of the off-preparation period. The vertical axis represents the generation level of the initialization bright points (as a score obtained by estimator's visual observation) in panel 10 just after plasma display apparatus 40 turned on. In the graph, the larger in amount the initialization bright points generate, the higher the score. For comparison, FIG. 9 additionally shows the graph of FIG. 5 in the broken line.

According to the embodiment, as shown in FIG. 9, the off-preparation period (necessary for effective decrease in initialization bright points generated just after power-on of plasma display apparatus 40) has a length shorter than that of the structure of the first exemplary embodiment.

When the structures of the first and the second embodiments are compared (on the supposition that each of the off-preparation period has the same length, for example, 0.1 sec), in the structure of the second embodiment, the all-cell initializing operation that enhances the stability of wall charge in the discharge cells can be performed frequently more than in the structure of the first embodiment.

According to the structure of the embodiment, as described above, the off-preparation period is disposed between the power-off time (at which enable signal C21 is turned off) and complete stop of application of driving voltage to panel 10. At the same time, during the off-preparation period, only the all-cell initializing operation is performed with no generation of the address pulses, the scan pulses, the sustain pulses, and down-ramp voltage L4. Further, the period between the all-cell initializing operations is determined to be shorter than that in normal operation. That is, only the all-cell initializing waveform is generated during the off-preparation period. With the structure above, the length of the off-preparation period that is necessary for effective decrease in initialization bright points generated just after power-on of plasma display apparatus 40 can be shorter than that of the structure of the first exemplary embodiment.

In the structure shown in FIG. 8, the off-preparation period starts just after turn-off of enable signal C21, but it is not limited thereto; as for the field that has already started at the turn-off of enable signal C21, the change from the normal-operation period to the off-preparation period can wait until the completion of the field.

According to the embodiment, the period between the all-cell initializing operations (i.e., the period between the generating times of the all-cell initializing waveforms) in the off-preparation period is determined to be shorter than that in normal operation. However, the aforementioned period may be the same in length as that in the normal operation. In that case, too, the off-preparation period has no generation of the address pulses, the scan pulses, the sustain pulses, and down-ramp voltage L4.

In the description of the second embodiment, initializing voltage Vi2 in the off-preparation period is determined to be the same as initializing voltage Vi2 in the normal operation, but they may be different from each other. For example, when initializing voltage Vi2 in the off-preparation period is set to be higher than that in the normal operation, the period for generating initializing discharge can be longer than that in the normal operation, which contributes to further stable accumulation of wall charge in the discharge cells.

Besides, in the description of the embodiment, up-ramp voltage L1 and down-ramp voltage L2 have the same gradient with no difference between the normal operation state and the off-preparation period, but the gradients are not necessarily the same.

The experiment by the inventor shows that the following setting is effective in decreasing the initialization bright points at the power-on time: the period between all-cell initializing operations in the off-preparation period is determined to be 3 msec, and the all-cell initializing operation is repeated at least six times. Accordingly, the aforementioned setting is employed in the embodiment. However, the aforementioned values are for purposes of illustration only and are not to be construed as limiting values. The length of the period between the all-cell initializing operations and the number of repeating times of the all-cell initializing operations should be set optimally for the characteristics of panel 10 and the specifications of the plasma display apparatus.

### Third Exemplary Embodiment

According to the structure described in the second embodiment, the voltage waveform of the all-cell initializing operation has no difference in shape in the normal operation and the off-preparation period. However, the waveform employed in the off-preparation period may be shaped different from that in the normal operation.

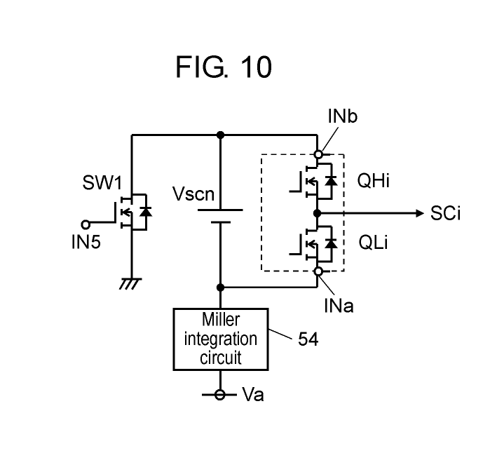

FIG. 10 partly shows the circuit diagram of the scan electrode driver circuit in accordance with the third exemplary embodiment. The scan electrode driver circuit of the embodiment is nearly the same as scan electrode driver circuit 43 of FIG. 6 with the exception that switching element SW1 is added. FIG. 10 therefore shows only the peripheral parts at which switching element SW1 is disposed, and other parts are omitted.

In the embodiment, as shown in FIG. 10, switching element SW1 is disposed between input terminal INb of switching elements QH1 through QHn and ground potential of 0(V). FIG. 10 shows the input terminal of switching element SW1 as input terminal IN5.

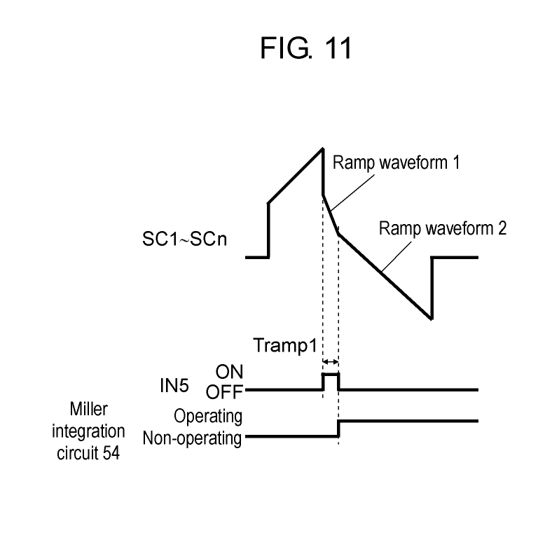

FIG. 11 shows the waveform of voltage for an all-cell initializing operation to be applied to scan electrodes 22 in the off-preparation period of the third exemplary embodiment. In addition to the waveform of driving voltage to be applied to scan electrodes 22, FIG. 11 shows working states of the signal for operating switching element SW1 (i.e. the signal to be applied to input terminal IN5) and Miller integration circuit 54.

In the embodiment, the down-ramp voltage, which is to be applied to scan electrodes 22 in an all-cell initializing operation performed in the off-preparation period, has a waveform shape different from that of down-ramp voltage L2 in an all-cell initializing operation performed in the normal operation.

Specifically, in the structure of the embodiment, period Tramp 1 is disposed at generation of the down-ramp voltage. Input terminal IN5 is kept on during period Tramp 1, by which the down-ramp voltage to be applied to scan electrodes 22 (shown as ramp waveform 1 in FIG. 11) has a sharp drop. After period Tramp1, operating Miller integration circuit 54 (as in the case of generating down-ramp voltage L2) generates a moderate down-ramp voltage to be applied to scan electrodes 22. The down-ramp voltage (shown as ramp waveform 2 in FIG. 11) moderately lowers, with a gradient of, for example, approximately −2.5V/μsec, toward voltage Vi4.

In the structure of the second embodiment, the period between the all-cell initializing operations in the off-preparation period is determined to be shorter than that in normal operation, accordingly, Miller integration circuit 54 in the off-preparation period works frequent more than in the normal operation. The structure therefore increases a load on Miller integration circuit 54.

According to the structure of the third embodiment, however, the period during which Miller integration circuit 54 is working in the all-cell initializing operation in the off-preparation period can be shorter than that in the normal operation, contributing to a reduced load on Miller integration circuit 54.

A sharp drop of the voltage to be applied to scan electrodes 22 in an initializing operation, as long as it occurs before generation of discharge in the discharge cells, does not adversely affect the initializing operation itself. Considering above, input terminal IN5 is kept on until immediately before generation of discharge in the discharge cells, during which (i.e., during period Tramp1) the voltage to be applied to scan electrodes 22 is falling sharply. The length of period Tramp1 should be determined optimally for the characteristics of panel 10 and the specifications of the plasma display apparatus.

Even in the structure described in the first embodiment, maintaining input terminals IN4 and IN2 on during period Tramp 1 allows the voltage for scan electrodes 22 to have a sharp drop.

Each control signal described in the embodiments does not necessarily have the polarity described in the embodiments; a control signal having opposite polarity can be employed, as long as it works similar to that in the structure described in the embodiments.

Each circuit block shown in the exemplary embodiments of the present invention may be formed as an electric circuit that performs each operation shown in the exemplary embodiment, or formed of a microcomputer programmed so as to perform the similar operation, for example.

In the example described in the exemplary embodiments, one pixel is formed of discharge cells of three colors of R, G, and B. Also a panel having discharge cells that form a pixel of four or more colors can use the configuration shown in this exemplary embodiment and provide the same advantage.

The aforementioned driver circuit is only shown as an example in the exemplary embodiments of the present invention. The present invention is not limited to the structure of the driver circuit.

The specific numerical values shown in the exemplary embodiments of the present invention are set based on the characteristics of panel 10 that has a 50-inch screen and 1024 display electrode pairs 24, and simply show examples in the exemplary embodiment. The present invention is not limited to these numerical values. Preferably, each numerical value should be set optimally for the characteristics of the panel, the specifications of the plasma display apparatus, or the like. Variations are allowed for each numerical value within the range in which the above advantages can be obtained. Further, the number of subfields, the luminance weights of the respective subfields, or the like is not limited to the values shown in the exemplary embodiments of the present invention. The subfield structure may be switched based on image signals, for example.

### INDUSTRIAL APPLICABILITY

The present invention allows a panel even having a high-definition large-sized screen to decrease initialization bright points that easily appear on the panel just after power-on of the plasma display apparatus, enhancing the quality of display image. Thus, the present invention is useful in providing a method of driving a panel and a plasma display apparatus.

### REFERENCE MARKS IN THE DRAWINGS

10 panel
21 front substrate
22 scan electrode
23 sustain electrode
24 display electrode pair
25, 33 dielectric layer
26 protective layer
31 rear substrate
32 data electrode
34 barrier rib
35 phosphor layer
40 plasma display apparatus
41 image signal processing circuit
42 data electrode driver circuit
43 scan electrode driver circuit
44 sustain electrode driver circuit
45 control signal generation circuit
50 sustain pulse generation circuit
51 initializing waveform generation circuit
52 scan pulse generation circuit
53, 54, 55 Miller integration circuit
56 constant current generation circuit
60 power supply circuit
62 main switch
63 driver power supply
64 standby power supply
65 on/off detector
70 control circuit
72 remote-switch controller
73 remote-switch signal receiver
76 power-supply controller
78 on/off controller
80 remote switch
Q1, Q2, Q3, Q4, Q5, Q6, Q21, QH1-QHn, QL1-QLn, SW1 switching element
C1, C2, C3, C31 capacitor
Di31 diode
Di9, Di10 zener diode
R1, R2, R3, R9, R12, R13 resistor
Q9 transistor
L1 up-ramp voltage
L2, L4 down-ramp voltage
L3 erasing ramp voltage

1. A method of driving a plasma display panel having a plurality of discharge cells, each of the discharge cells including a data electrode and a display electrode pair formed of a scan electrode and a sustain electrode,
wherein one field period is formed by a plurality of subfields, each of the subfields having:
an initializing period for generating an initializing discharge in the discharge cells;
an address period for applying scan pulses to the scan electrodes and applying address pulses to the data electrodes; and
a sustain period for applying sustain pulses to the display electrode pairs,
the method comprising:
halting generation of the address pulses, the scan pulses, and the sustain pulses for a predetermined period after power-off of a plasma display apparatus having the plasma display panel.

2. A plasma display apparatus comprising:
a plasma display panel having a plurality of discharge cells, each of the discharge cells including a scan electrode, a sustain electrode, and a data electrode;
a driver circuit for generating a driving voltage waveform to be applied to the scan electrode, the sustain electrode, and the data electrode, and for driving the plasma display panel while one field includes a plurality of subfields, each of the subfields having an initializing period for generating an initializing discharge in the discharge cells, an address period for generating an address discharge in the discharge cells, and a sustain period for generating a sustain discharge in the discharge cells; and
a main switch for turning on/off of a power supply that feeds power to the driver circuit,
wherein the driver circuit applies an all-cell initializing waveform to generate the initializing discharge in all of the discharge cells to the scan electrode two-or-more times after a turn-off of the main switch.

3. The plasma display apparatus of claim 2, wherein the driver circuit sets a length of a period, in which the all-cell initializing waveform is applied to the scan electrode after the turn-off of the main switch, to be shorter than a length of one field period.

4. The plasma display apparatus of claim 2, wherein the driver circuit sets an initializing voltage of the all-cell initializing waveform to be applied to the scan electrode after the turn-off of the main switch higher than an initializing voltage of the all-cell initializing waveform in a normal operation state.
